(19) United States
(12) Patent Application Publication
(10) Pub. No.: US 2017/0343485 A1
(43) Pub. Date: Nov. 30, 2017

(54) RETRIEVAL OF P-BAND SOIL REFLECTIVITY FROM SIGNALS OF OPPORTUNITY

(71) Applicant: Purdue Research Foundation, West Lafayette, IN (US)

(72) Inventors: James L. Garrison, Lafayette, IN (US); Yao-Cheng Lin, West Lafayette, IN (US)

(73) Assignee: Purdue Research Foundation, West Lafayette, IN (US)

(21) Appl. No.: 15/592,192

(22) Filed: May 10, 2017

Related U.S. Application Data
(60) Provisional application No. 62/334,410, filed on May 10, 2016.

(51) Int. Cl. G01N 22/04; G01S 13/88; G01S 17/48

(52) U.S. Cl. CPC G01N 22/04; G01S 17/48; G01S 13/885; G01N 2223/101; G01N 2223/052

(57) ABSTRACT

A system and method for determining moisture content of soil, comprising providing bistatic radar configuration to measure soil reflectivity in UHF and S-band, cross-correlating between Sky-viewed and Earth-viewed signals and reflected signals in order to isolate the reflected signals, and correlating the isolated reflectesd signal to moisture content of the soil.

### GOVERNMENT SUPPORT CLAUSE

This invention was made with government support under NNX14AE80G awarded by NASA. The government has certain rights in the invention.

### TECHNICAL FIELD

The present disclosure generally relates to ground penetrating signals, and in particular to signals and systems designed to determine soil condition.

### BACKGROUND

This section introduces aspects that may help facilitate a better understanding of the disclosure. Accordingly, these statements are to be read in this light and are not to be understood as admissions about what is or is not prior art.

Remote sensing of the sub-surface water content in the soil has received some attention as of late. Knowledge of the available water for plants would greatly improve the efficiency of irrigation. Water for irrigation is becoming very scare in certain locations (e.g. California, where 40% of the water resources go to agriculture). Plants absorb water through their roots, so an accurate assessment of the available water must incorporate the distribution of water from the surface down to the depth of the roots, the so-called “Root-Zone Soil Moisture” (RZSM) which can extend to about 1 meter below the surface. Remote sensing from an airborne instrument can provide the most efficient method for obtaining this information, as the receiver can be directed to a specific field area and collect measurements at a high resolution (as compared to satellite instruments), and can survey an entire field with high spatial density in a short period of time (as compared to direct measurements with “in-situ” sensors.

There are presently several approaches to measure soil moisture. In situ methods require the insertion of a probe in the soil, or the collection of a sample, at the location where the measurement is made. Whereas this can be the most precise measurement, and is usually the one used to calibrate remote sensing measurements, it is limited to a single point. Water distribution across a field can be heterogeneous. With the advent of precision agriculture, it is possible to control the optimal allocation of irrigation, if data is available showing the variation of the soil moisture over a field. However, deployment of in situ sensors at a density necessary to map this variation is not feasible due to the cost of such a large number of sensors, their maintenance and the communication infrastructure to extract data from them, collectively.

Remote sensing provides an advantage in this area, as a large area can be sampled in a very short period of time. Remote sensing of soil moisture makes use of the difference in reflectivity of microwave radiation, between water (high reflectivity) and dry soil (low reflectivity). There are two current approaches to remotely sensing soil moisture based upon this principle. The first approach, radiometry, applies the fundamental relationship between reflectivity and emissivity based on conservation of energy principals.

Emissivity+reflectivity=1

Emissivity can be measured from the apparent temperature of the surface as an emitter of radiation. This naturally-emitted radiation is very weak, and its measurement requires an extremely sensitive receiver and extensive calibration. These measurements are also very susceptible to radio-frequency interference (RFI) from man-made transmitters. Finally, the antenna size is determined by the surface resolution and is proportional to the wavelength. These features of radiometry, essentially limit its application to L-band (1.4 GHZ) and higher frequencies. Examples of systems using radiometry include the SMOS (Soil Moisture and Ocean Salinity) satellite operated by the European Space Agency (ESA) and the SMAP (Soil Moisture Active/Passive) recently launched by NASA. Predecessor instruments include AMSR-E (Advanced Microwave Scanning Radiometer—EOS) instrument on the Aqua satellite. However, these systems suffer from the stated limitations.

The second approach to the measurement of soil moisture uses the backscatter of radar signals from an active transmitter. In this configuration, referred to as “monostatic” radar, the transmitted signal, and the reflected signal both follow the same path from the platform to the receiver. SMAP will include an active radar in addition to the passive radiometer. Active radar can achieve a higher resolution than that of the passive radiometer. It does, however, require a spectrum allocation and license. The interference, spectrum allocation and antenna size issues also limit active radars to L-band and higher, in general. ESA has proposed the BIOMASS satellite, which will use an active P-band radar (420 MHz) to measure vegetation with a proposed launch in 2020. This mission includes the technical challenge of launching a 12-meter diameter antenna. Furthermore, it will not presently be allowed to operate over North America or Europe due to interference with the Space Objects Tracking Radar (SOTR) network. The JPL-AirMOSS (Airborne Microwave Observatory of Subcanopy and Subsurface) airborne instrument also uses a P-band radar, at 280-440 MHz.

A new remote sensing technology, using signals of opportunity (“SoOp”) has been under development in various forms for about the last 20 years. In addition to the, more developed, work in ocean remote sensing, measurements of reflected signals from the Global Navigation Satellite System (GNSS) have been shown to also be used for remote sensing of soil moisture. GNSS transmissions are also limited to L-band, and thus are sensitive to only the top few cm of the soil, just as with radar and radiometry in the same frequency bands. Signals of opportunity, however, can provide the high signal to noise ratio of active radar, without the use of a transmitter. Use of a forward scatter, or “bistatic” geometry also presents a higher signal power to the receiver, as compared to the monostatic or backscatter configuration used by active radar. Through making use of the same signals which cause interference, these signals of opportunity methods (also referred to as bistatic radar, or reflectometry) are expected to be more robust to interference than systems using backscatter from dedicated transmitters (radar) or thermal emission from the surface (radiometry).

Therefore, there is an unmet need for a novel approach the accurately measure soil condition, in particular moisture content in the soil from a high altitude allowing coverage of a large area providing high resolution data.

### BRIEF DESCRIPTION OF THE DRAWINGS

The above and other objects, features, and advantages of the present invention will become more apparent when taken in conjunction with the following description and drawings wherein identical reference numberals have been used, where possible, to designate identical features that are common to the figures, and wherein:

FIG. 1a is a graph showing soil moisture vs. reflectivity for P-band and S-band signals.

FIG. 1b is a graph showing reflectivity vs. soil moisture for P-band and S-band signals.

FIG. 2 shows a diagram of direct and reflected signals.

FIG. 3 is a graph showing soil moisture vs. depth.

FIG. 4a is a graph showing soil moisture vs. reflectivity for reverse polorization.

FIG. 4b is a graph showing soil moisture vs. reflectivity for same polarization.

FIG. 5a is a graph showing soil moisture vs. reflectivity for reverse circular polorization.

FIG. 5b is a graph showing soil moisture vs. reflectivity for same circular polarization.

FIG. 5c is a graph showing reflectivity vs. soil moisture for P and S bands.

FIG. 6 is a graph showing varying calibration implementations according to various aspects.

FIG. 7 is a graph showing delays vs. correlation according to various aspects.

FIG. 8 is a diagram illustrating a soil moisture measurement system according to various aspects.

FIG. 9 is a diagram showing a transfer switch configured to switch between Skyview and Earthview antennas according to various aspects.

FIG. 10 is a diagram showing a calibration sequence according to various embodiments.

FIG. 11 is a diagram showing details of a switching mode for the swap mode according to various aspects.

FIG. 12 is a diagram showing details of a switching mode for a reference or noise mode according to various aspects.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A novel soil condition determination system is disclosed. This disclosure describes a new sensing technology for precision agriculture. It encompasses an instrument and related data processing to extract estimates of sub-surface soil moisture from measurements made on an airborne platform (which could include piloted or un-piloted vehicles).

This technology uses reflection of electromagnetic radiation from the surface of the Earth to measure the water content of the soil (soil moisture). The fundamental physical principle involved in this measurement is the reflectivity of the soil surface, the fraction of incident radiation reflected forward vs. that absorbed by the surface, depends on the amount of water in the soil. Reflectivity of water is higher than that of dry soil, so as the soil moisture increases, the power in the reflected signal would also increase.

The depth of penetration of an electromagnetic signal is approximately proportional to the wavelength. Satellite and airborne remote sensing uses microwave frequencies, typically in L-band (1.4 GHz) and above. At these frequencies, the signal penetrates only the top few cm of the soil, thus producing a direct measurement of only moisture within this thin layer on the top of the soil. Many problems in agricultural production will require knowledge of the water distribution in from the surface down to the “root zone”, which is approximately a meter below the surface. With present technology, using L-band and higher, this root-zone soil moisture (RZSM) can only be estimated by extrapolating the surface measurements using a model for the distribution of water in the soil.

The present technology for making this measurement uses either an active radar, to transmit the incident signal, from the same platform (airborne or satellite), at which the reflected signal is observed, also known as a monostatic configuration. The frequencies available for this application are only those allocated for scientific use (radio astronomy). These are severely limited and may be susceptible to interference from other transmitters at nearby frequencies. An alternative approach used for remote sensing of soil moisture makes use of measurement of the natural emission of microwave radiation from the soil surface, using a radiometer, a very sensitive receiver.

L-band is the lowest practical frequency for either of these two existing techniques, due to the presence of many communication transmitters operating at lower frequencies, and the required antenna size.

The system and method described herein makes use of signals transmitted from satellites for other purposes (typically communications) which are reflected from the soil surface. A specialized receiver compares the signal observed directly from the transmitting satellite with that reflected from the soil surface through the mathematical process of cross-correlation. Cross-correlation will provide a measurement of the reflectivity of the soil surface. By re-utilizing man-made signals already transmitted, vs. using natural emission or transmission of a dedicated signal, it opens the possibility of using any frequency used for communication or navigation. In the particular case of soil moisture sensing, this allows the use of frequencies below L-band, with longer wavelengths and thus deeper penetration. A large number of satellite communication transmitters operate in P-band (known as UHF/VHF in the communications field.). These include a frequency allocation to government use from 225-328.6 MHz. Commercial satellite transmissions are also allowed between 137 MHz and 138 MHz, and 148 to 150 MHz. At these frequencies, the penetration depth ranges from approximately 9 cm to 22 cm, providing better sensing of the soil below the surface and into a significant portion of the root-zone. It is not feasible to operate either an active radar or passive radiometer in space at these frequencies due to the required antenna size, the lack of a special allocation for scientific use, and the presence of interference from high-powered communications transmitters.

The system and method disclosed herein comprises an instrument and related data processing to extract an estimate of the volumentric soil moisture from reflections of P-band communication satellite signals. This system may be installed on light aircraft and un-piloted aerial vehicles (UAV's, “drones”), and used in surveying agricultural fields, to monitor the sub-surface moisture content in the soil for precision agriculture. For example, these measurements may be used to regulate irrigation, to more selectively and thereby efficiently provide water as needed for plant growth and reduce waste. The technology may also have applications in forestry and disaster preparation, in the prediction and management of drought, forest fire, or flood risk.

Unlike past experience with signals of opportunity, there are unique approaches necessary to work with these P-band signals from an airborne platform. These arise from the longer wavelengths involved, and the very low bandwidth of the transmitted data. These prevent the use of directional antennas, or time-delay to clearly separate the direct and reflected signals. The following features are of interest:
1) Multiple cross-correlation array to generate pairs for cross correlations between the sky-view and earth-view antennas in both Linear polarization components.
2) Formation of observables (Gammal and Gamma 2) from these cross-correlations given a functional relationship to surface reflectivity.
3) Calibration of the observables, using models or experimental data, to account for the cross-interference between the direct and reflected signals, visible in both the Earth and Sky-view antennas simultaneously
4) Antenna design for installation on side of aircraft, to provide maximum gain in the direction of the desired signal (Direct-Skyview, Reflected-Earth view) and maximum attenuation in the direction of the desired null (Reflected-Skyview, Direct-Earthview).
5) Kalman filter method for simultaneously estimating antenna parameters and surface reflectivity from the combined direct and reflected signals, using measurements of the cross-correlation pairs.

Data collected at L-band and higher frequencies, regardless of the instrument principle or geometry, will only be sensitive to moisture in the top few cm of the soil. Estimates of the sub-surface soil moisture can be obtained by fitting a hydrological model for the flow of water from the surface, to these measurements, using any number of data inversion methods, such as least squares, Kalman filters, or the simulated annealing. The “Level-4” data product from the SMAP mission is a model inversion of this type. The accuracy of these methods, of course, will depend upon the quality of the underlying physical models and their assumptions, such as the length scale over which homogenous properties can be assumed.

The system and method of the present disclosure offer the best direct measurement of sub-surface soil moisture available. It makes use of lower-frequency signals which are required to penetrate the soil, but which cannot be used for active or passive remote sensing due to interference, and the large antenna size. The signals of opportunity concept, which re-utilizes existing transmitter sources, will produce high signal to noise ratio measurements with low instrument power requirements. Resolution will be determined only by the frequency of the signal, under the assumption of a near-specular reflection, not the antenna size. Signals of opportunity measurements can also make use of the direct signal power for calibration. These features will enable the use of this instrument on small airborne platforms such as UAV's.

Airborne measurements provide higher resolution than satellite measurements, and can be targeted specifically to the areas of interest.

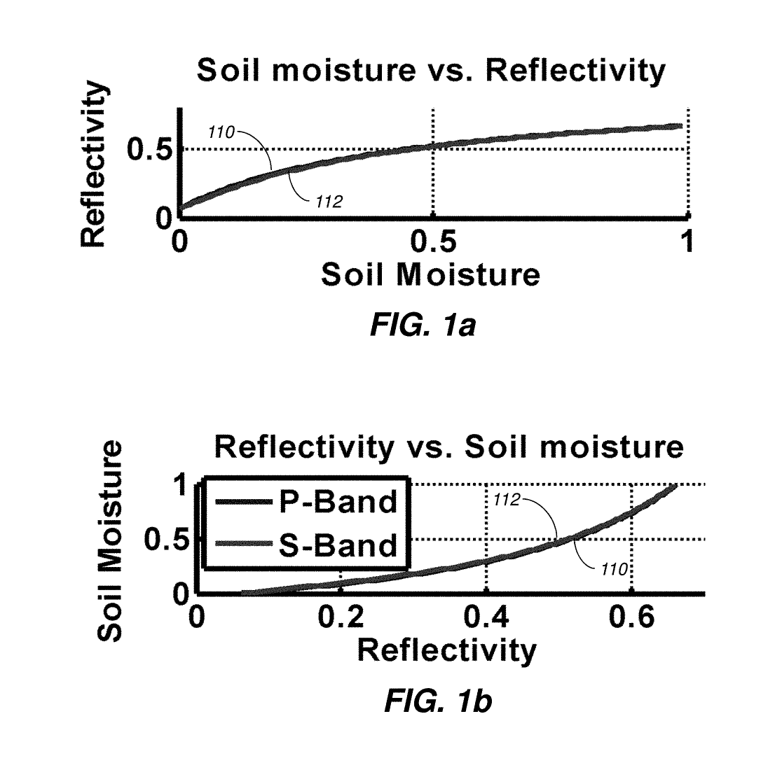

The soil moisture retrieval can be simplified as a reflectivity estimation problem. The soil reflectivity will be estimated from the correlations between Sky-viewed and Earth-viewed signals using dedicated antennas, RF filter, signal processing algorithms and antennas and receiver calibrations. As shown in FIGS. 1a and 1b, the P-Band (110) and S-Band (112) are practically on top of each other.

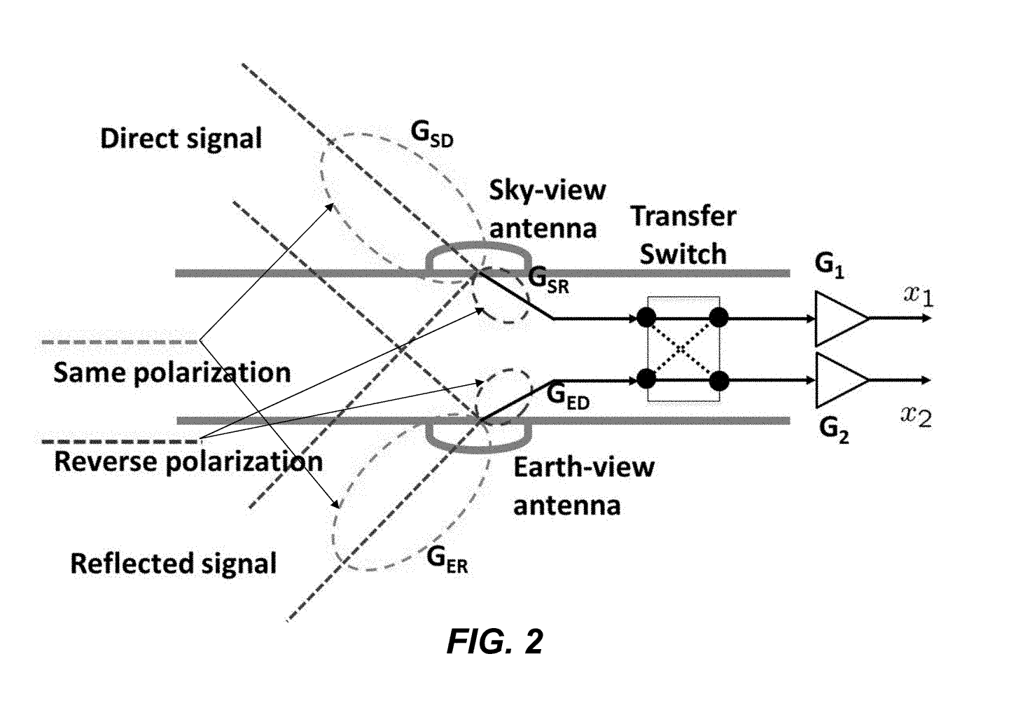

As shown in FIG. 2, the direct and reflected signals have the following structure, where α is the data signal, ω_{b} is the baseband frequency, ω_{b} is the frequency of the signals in space and τ stands for time delay:

$$\begin{matrix}{x}_{D} ( t ) = \sqrt{{C}_{D}} a ( t - {τ}_{D} ) {e}^{j {ω}_{b} t} {e}^{- j {ω}_{e} {τ}_{D}} \\ {x}_{R} ( t ) = \sqrt{{C}_{R}} a ( t - {τ}_{R} ) {e}^{j {ω}_{b} t} {e}^{- j {ω}_{e} {τ}_{R}}\end{matrix} Γ = \frac{{C}_{R}}{{C}_{D}}$$

$${\hat{Γ}}_{1} \approx \frac{{R}_{22}^{n} ( 0 ) - {G}_{1} {σ}_{1}^{2}}{{R}_{11}^{n} ( 0 ) - {G}_{2} {σ}_{2}^{2}} \frac{{G}_{1}}{{G}_{2}} \frac{{G}_{SD}}{{G}_{ER}}$$

$${\hat{Γ}}_{2} \approx {( \frac{\vert {R}_{12}^{n} ( {τ}_{RD} ) \vert}{{R}_{11}^{n} ( 0 ) - {G}_{2} {σ}_{2}^{2}} )}^{2} \frac{{G}_{1}}{{G}_{2}} \frac{{G}_{SD}}{{G}_{ER}}$$

The approaches to estimate reflectivity include calibration of channel gain, antenna gain, and channel noise. If the antenna gain along the opposite path (G_{SR} and G_{ED}) are not zeros, there is a bias of reflectivity estimation. To correct the bias due to the interference, an empirical calibration of Direct-Reflection interference can be performed.

The penetration depth (δₚ) depends on the frequency (f) and dielectric constant of material.

$${δ}_{p} = \frac{λ}{4 π \vert Im [ \sqrt{ɛ} ] \vert} = \frac{c}{4 π f \vert Im [ \sqrt{ɛ} ] \vert}$$

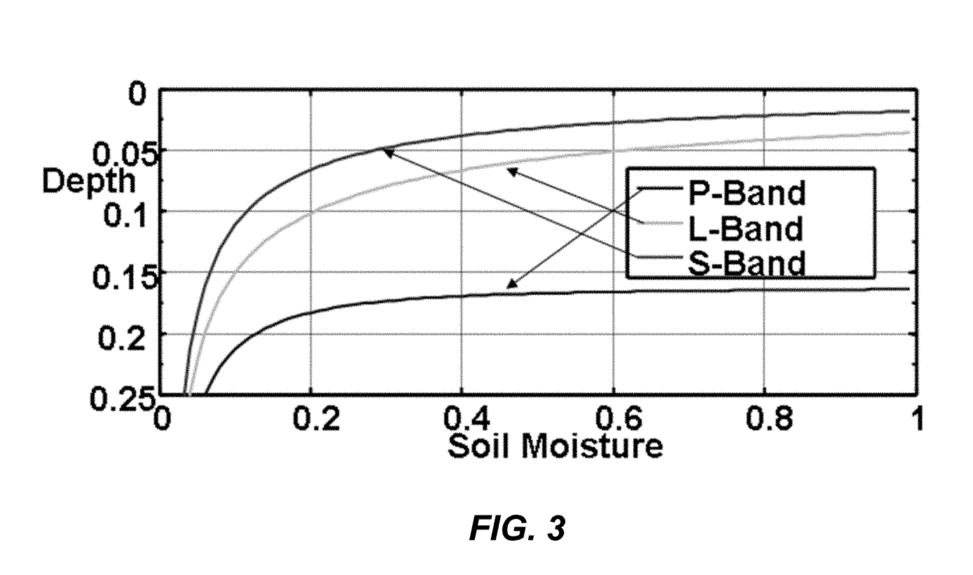

FIG. 3 shows the relationship between the penetration depth and soil moisture. The texture of soil in the illustrated case is Sand 40%, Clay 20% and Slit 40%.

The dielectric constant (ε) of soil is a function of temperature, soil texture, salinity, and Soil moisture. Reflectivity is the function of dielectric constant and incident angle (θ) Γₗᵣ and Γₗₗ are the reflectivity for the reverse and same circular polarization, respectively.

$${γ}_{hh} = \frac{cos θ - \sqrt{ɛ - {sin}^{2} θ}}{cos θ + \sqrt{ɛ - {sin}^{2} θ}}$$

$${γ}_{vv} = \frac{ɛ cos θ - \sqrt{ɛ - {sin}^{2} θ}}{ɛ cos θ + \sqrt{ɛ - {sin}^{2} θ}}$$

$${Γ}_{lr} = {\vert \frac{{γ}_{hh} - {γ}_{vv}}{2} \vert}^{2} , {Γ}_{ll} = {\vert \frac{{γ}_{hh} + {γ}_{vv}}{2} \vert}^{2}$$

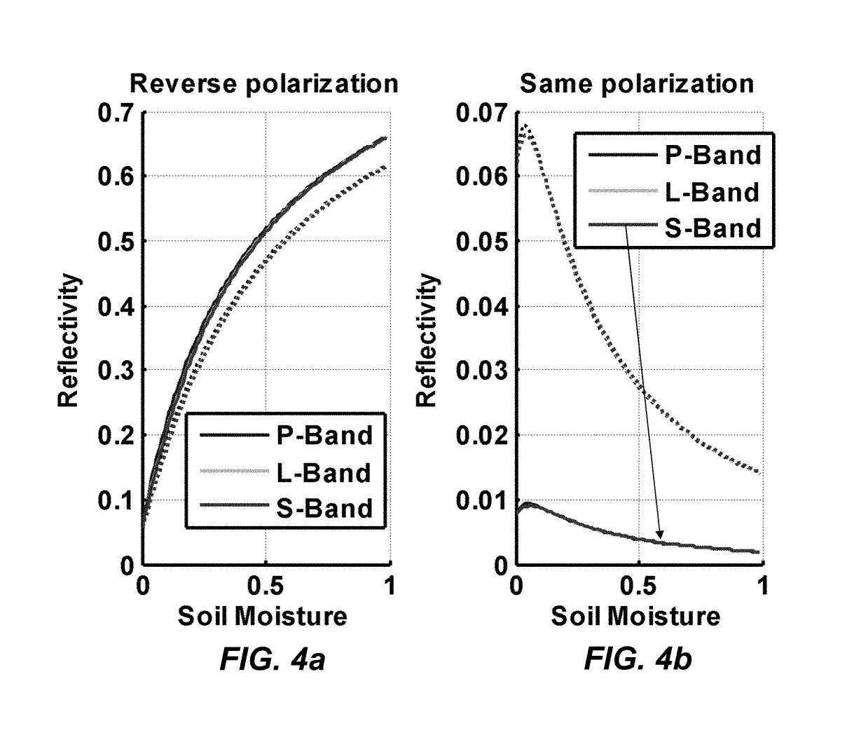

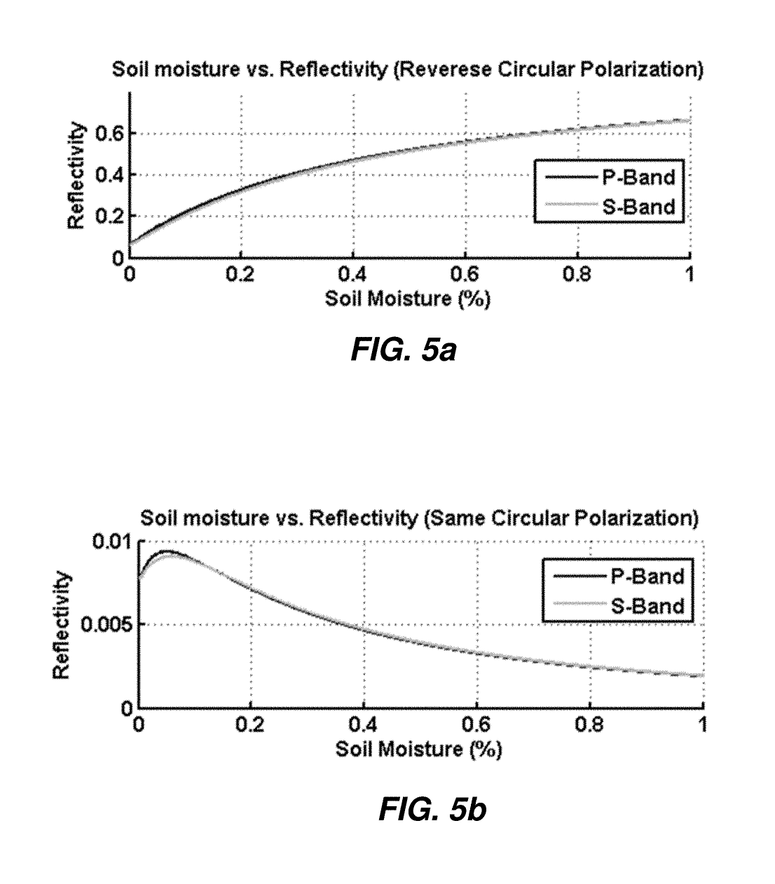

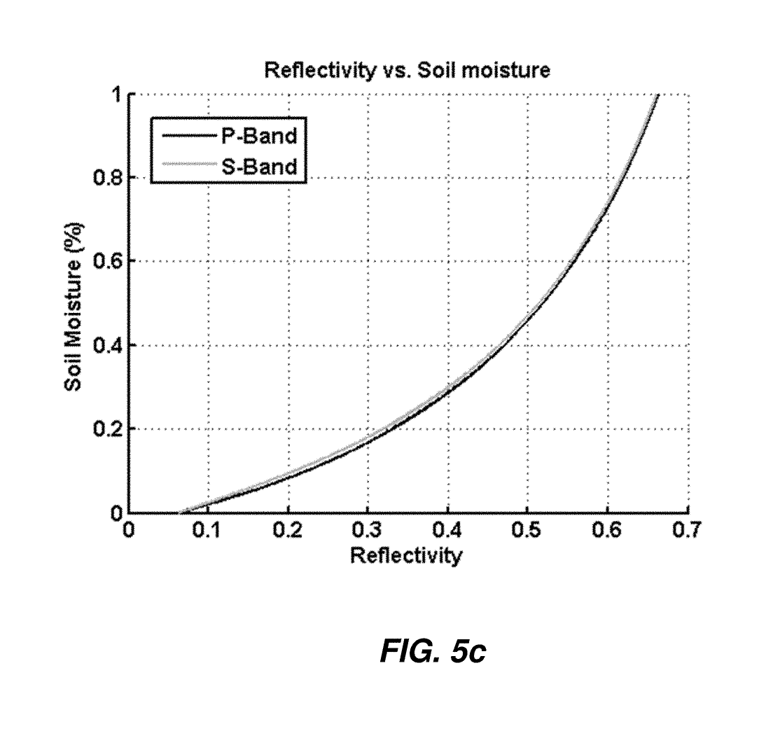

The dielectric constant of soil depends on the soil moisture, and the reflectivity is a function of the dielectric constant. Therefore, the relationship between the soil moisture and reflectivity can be established when the soil texture, frequency, and salinity are known, as shown in FIGS. 4a and 4b, also illustrated in FIGS. 5a, 5b, and 5c.

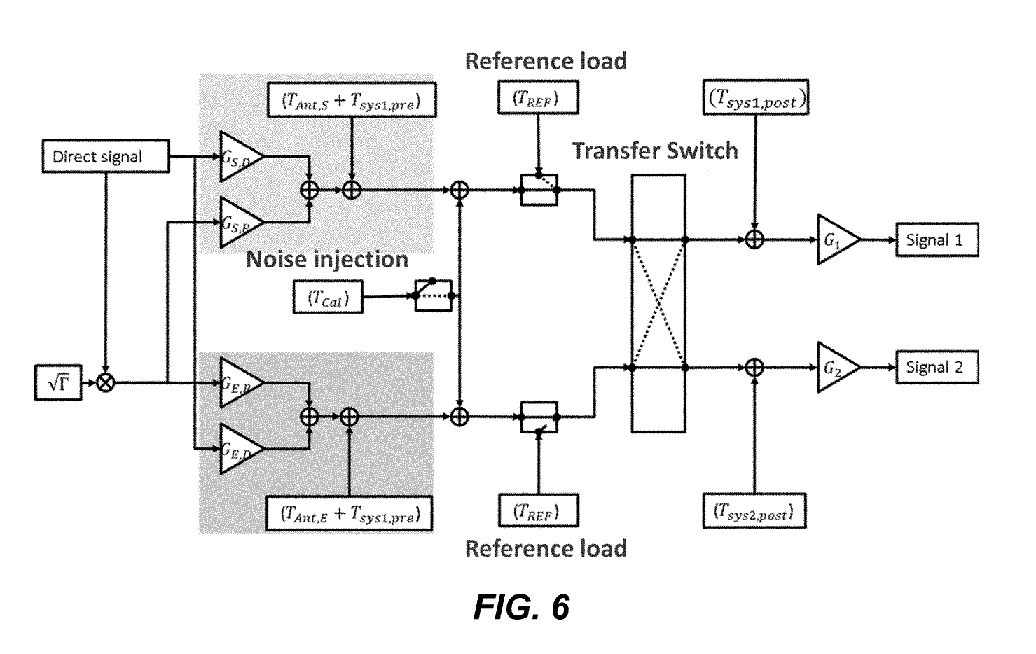

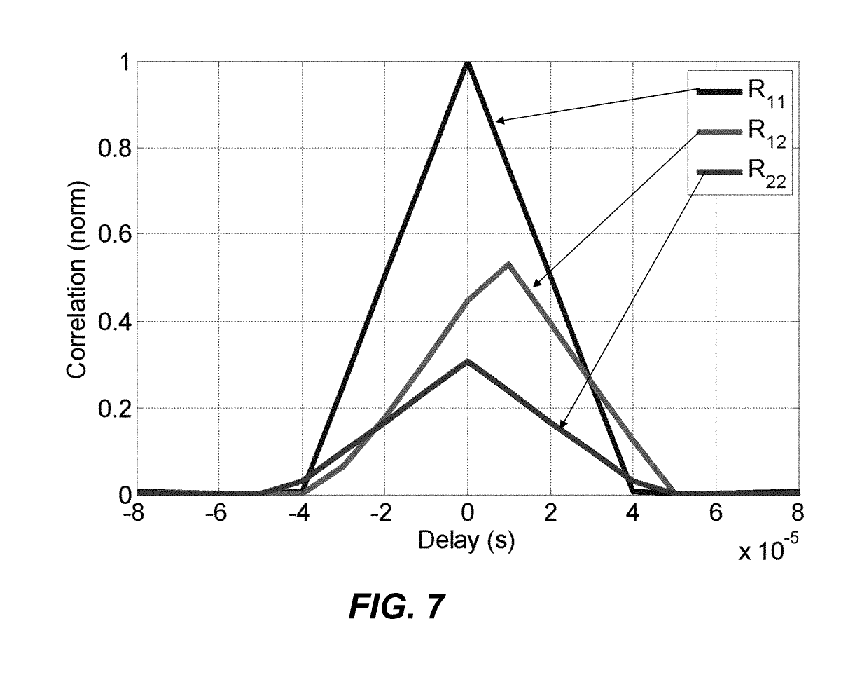

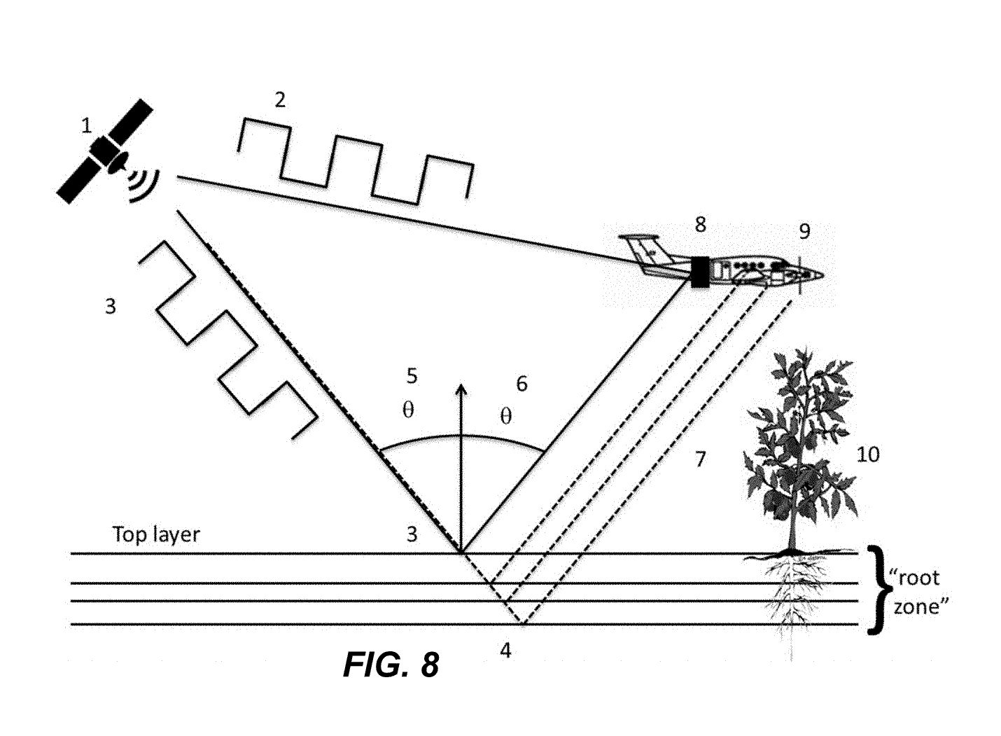

There are three calibration methods including noise injection, reference load, and antenna swapping, as illustrated in FIG. 6.

The signals in the receiver are:

x₁(t)=√\vec{G_{1,D}}x_{D}(t)+\sqrt{G_{1,R}}x_{R}(t)+n₁(t)

x₂(t)=√\vec{G_{2,D}}x_{D}(t)+\sqrt{G_{2,R}}x_{R}(t)+n₂(t)

G_{1,D}=G₁G_{SD}

G_{1,R}=G₁G_{SR}

G_{2,D}=G₁G_{ED}

G_{2,R}=G₂G_{ER}

The auto- and cross-correlations between these signals can be modeled as:

R_{1,1}(τ^{s})={[g_{1d}²+g₁ᵣ²]Rₐ(τ^{s})+g_{1d}g₁ᵣ[Rₐ(τ^{s}−τ_{RD}^{s})e^{jω}^{ₑ}^{τ}^{_{RD}}+Rₐ(τ^{s}+τ_{RD}^{s})e^{-jω}^{ₑ}^{τ}^{_{RD}}]}φ_{b}+σ₁²(τ^{s})n₁₁δ(τ^{s})

R_{1,2}(τ^{s})={[g_{1d}g_{2d}+g₁ᵣg₂ᵣ]Rₐ(τ^{s})+g_{1d}g₂ᵣ[Rₐ(τ^{s}−τ_{RD}^{s})e^{jω}^{ₑ}^{τ}^{_{RD}}+g₁ᵣg_{2d}Rₐ(τ^{s}+τ_{RD}^{s})e^{-jω}^{ₑ}^{τ}^{_{RD}}]}φ_{b}+n₁₂(τ^{s})

R_{2,2}(τ^{s})={[g_{2d}²+g₂ᵣ²]Rₐ(τ^{s})+g_{2d}g₂ᵣ[Rₐ(τ^{s}−τ_{RD}^{s})e^{jω}^{ₑ}^{τ}^{_{RD}}+Rₐ(τ^{s}+τ_{RD}^{s})e^{-jω}^{ₑ}^{τ}^{_{RD}}]}φ_{b}+σ₂²δ(τ^{s})n₂₂δ(τ^{s})

with gᵢₖ=\sqrt{G_{l,k}Cₖ}φ_{b}=e^{jω}^{ₑ}^{τ}^{^{a}}

The auto- and cross-correlations model is non-linear and depends on several unknown parameters: the soil reflectivity, the receiver channels gains sand noises, the antennas gains and the space phase between the direct and reflected signals. These parameters will be estimated as states of an Extended Kalman Filter, based on the observation of four correlations lags.

Two methods to determine reflectivity estimates are provided, the ratio of the auto-correlations and the ratio of cross- to auto-correlation, have been defined, allowing soil moisture to be retrieved using established empirical models for the soil dielectric constant. Using synthetic signals having realistic noise power, a calibration function has been developed to correct these observables, accounting for the cross-channel interference.

In certain aspects, as shown in FIG., a communication satellite 1 generates a transmission signal, transmitted in wide range of directions. A line of sight signal 2 can be received by a receiving antenna 8 on an aerial platform 9 (e.g., a fixed wing airplane), while another signal 3 travels along the ray-path from the satellite to reflect from the top surface of soil 3 in a given area, or vegetation growth on top of the soil. The incident signals reaching the soil 3 penetrate different depths (between 3 and 4) and are reflected outwards accordingly (i.e., one reflection for one penetrating depth and another reflection for another penetrating depth), i.e., some portion of the signal penetrates deeper into the soil to reflect at multiple depths.

Penetration depth is approximately proportional to wavelength, so lower frequencies (larger wavelengths penetrate deeper). L-band (e.g. NASA SMOS or ESA SMAP instruments, operating at 1.4 GHz) penetrates to 2-5 cm. P-band (230-270 MHz) can penetrate approximately 6-8 times deeper, or roughly 12-40 cm. Soil moisture within the “root zone” the depths of plant roots, is most important for predicting agricultural production and understanding the absorption of water by plants. This is typically considered the top meter of the soil. Reflection for P-band wavelengths (˜1 meter) will generally be approximated as specular, such that the angle of incidence 5 (indicated by θ) equal to the angle of reflection 6. Reflectivity of the soil is strongly dependent upon the water content often expressed as “volumetric soil moisture”(volume of water)/(volume of soil). The functional relationship between soil moisture and reflectivity is well established from past experimental measurements and defined in empirical models. Models also depend upon soil composition. Reflected ray paths—with intensity proportional to the reflectivity at each layer. Total scattered power is the combination of that in the rays from multiple depths. Signals from both the direct 2 and reflected ray paths 7 are received by an antenna with 2 the beams identified as “sky-view” (antenna pointed toward the satellite) and “Earthview” (antenna pointed toward soil).

Antenna 8 can be mounted on any type of platform, including satellites, aircraft, unpiloted aerial vehicle (UAV's, e.g. “drones”), or fixed installations, such as tower.

The sky-view antenna can be a separate, physical antenna, or a “smart antenna” beam formed using an antenna array, using common techniques known in the field. Beam of antenna is oriented in the predicted direction of the direct signal. If the design allows such control, a null of the antenna is steered to the direction of the reflected ray path. The earth-view antenna can be similarly design as the sky-view, but with a beam directed to the reflected ray path and optionally a null directed to the reflected ray path.

A calibration source can be used to calibrate the system which could be a noise source at a controlled temperature, or a synthetic signal of know properties.

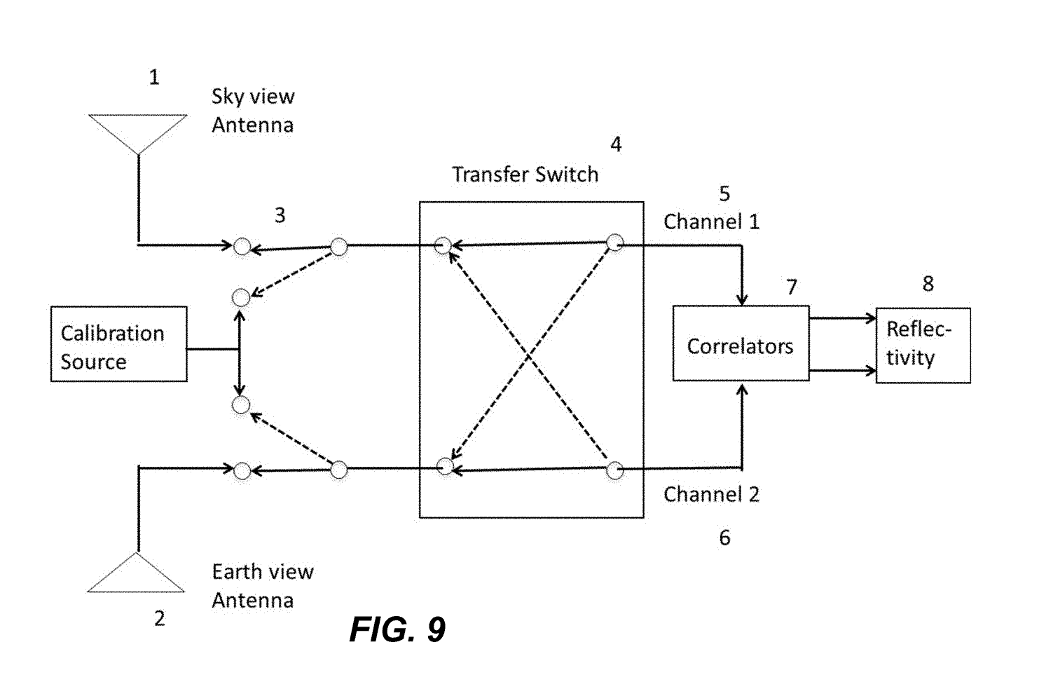

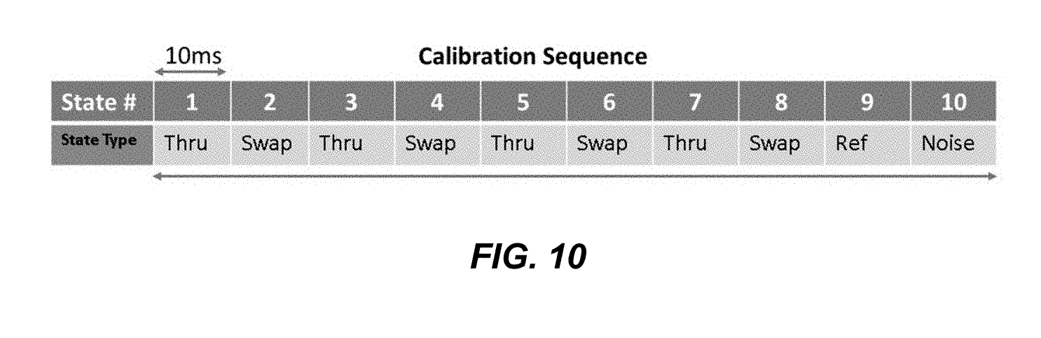

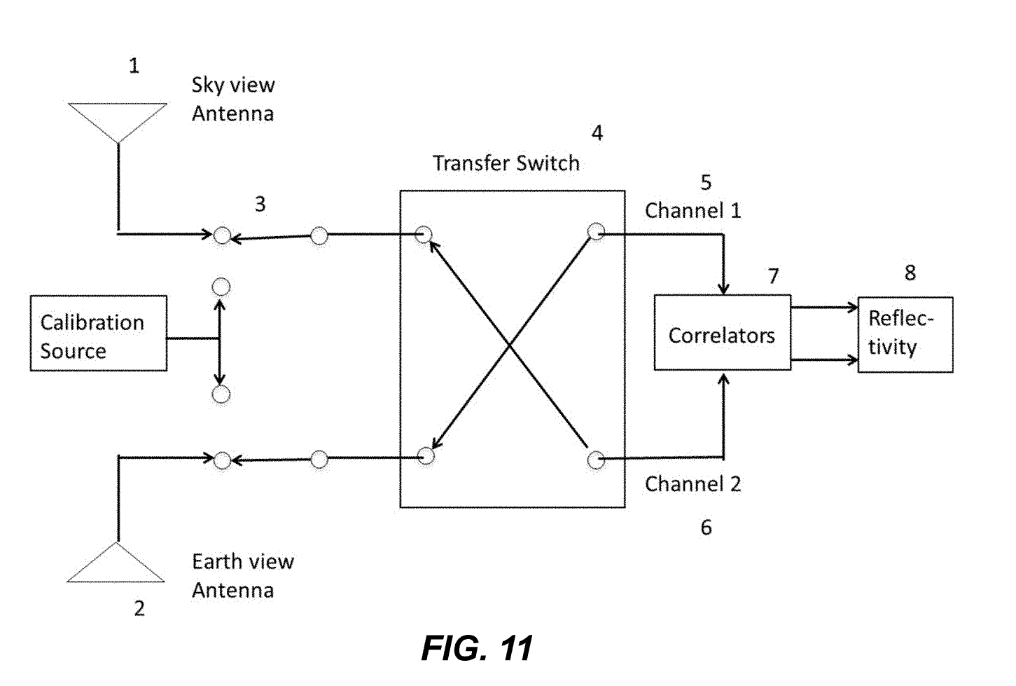

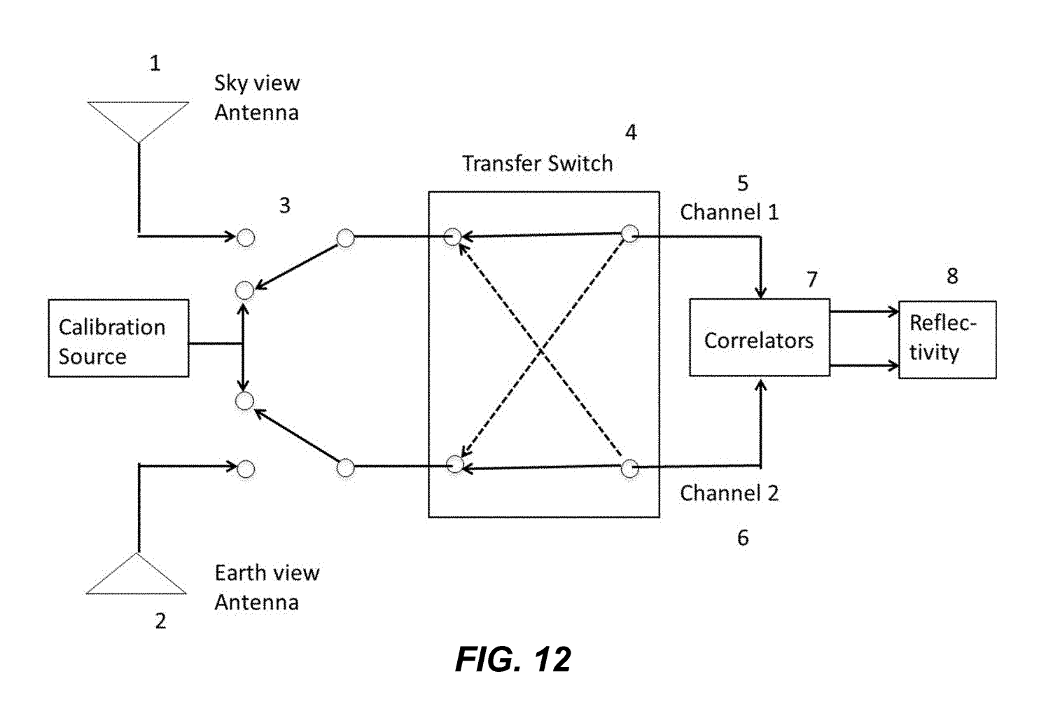

A transfer switch shown in FIG. 9 is configured to switch between Skyview and Earthview antennas to a receiver channels 1 and 2. The switch has 2 modes: a) Thru mode: Skyview coupled to channel 1 and Earthview coupled to channel 2; and b) Swap mode: Skyview coupled to Channel 2 and Earthview coupled to channel 1. Outputs of the transfer switch are sent to 2 receivers of identical design. The swap process with the transfer switch is used to calibrate the gain differences. A correlator in the receiver computes the autocorrelation of the Channel 1 and 2 and the cross-correlation between channels 1 and 2 using standard methods in digital signal processing. Correlation can be performed on a number of discrete “lags” between the channels. An estimated reflectivity (G) is computed from the outputs of the correlator as

$$Γ = {\vert \frac{R 12}{R 11} \vert}^{2}$$

Where R12 is the cross-correlation between channel 1 and channel 2 and R11 is the autocorrelation of channel 1. Switch 3 is turned to the calibration source for a small fraction (˜10%) of the data collection time. Indicated as “Ref” or “noise” in the following exemplary timeline. Transfer switch 4 is switched from “Thru” to “Swap” for equal periods of time as shown in FIG. 10. Data computing estimated reflectivity is obtained for each of these ties. Details of the switching mode for the swap mode is illustrated in FIG. 11. Details of the switching mode for the reference or noise mode is illustrates in FIG. 12.

Those having ordinary skill in the art will recognize that numerous modifications can be made to the specific implementations described above. The implementations should not be limited to the particular limitations described or the claim provided. Other implementations may be possible.

1. A method for determining moisture content of soil, comprising:
providing bistatic radar configuration to measure soil reflectivity in UHF and S-band;
cross-correlating between Sky-viewed and Earth-viewed signals and reflected signals in order to isolate the reflected signals; and
correlating the isolated reflected signal to moisture content of the soil.
